(19) United States
(12) Patent Application Publication
(10) Pub. No.: US 2001/0045936 A1
(43) Pub. Date: Nov. 29, 2001

(54) Computer pointing system

(76) Inventor: Mahmoud Razzaghi, San Diego, CA (US)

Correspondence Address: Mahmoud Razzaghi, 10558 Caminito Flores, San Diego, CA, 92126, US

(21) Appl. No.: 09/768,739

(22) Filed: Jan. 23, 2001

Related U.S. Application Data
(60) Provisional application No. 60/178,020, filed on Jan. 24, 2000.

(51) Int. Cl. G09G 5/00

(52) U.S. Cl. 345/156

(57) ABSTRACT

In a computer having a processing unit, a coordinate input device such as a mouse and a display screen, a video image of a cursor or pointer can be moved and positioned on the screen by moving the mouse. The speed of the pointer is changed according to the amount of movement or travel distance of the mouse or pointer. As the mouse or pointer is moved farther from an initial position, the speed of the pointer is increased. When the mouse is stopped or its speed is reduced below a given value, the process stops and restarts with the next movement of the mouse. In one embodiment, the pointer moves at a low speed in fixed relation with the mouse for a first part of the movement of the mouse or pointer. The increase in pointer speed starts after the completion of the first part of the movement. In another embodiment, the speed of the pointer is increased gradually or stepwise form the beginning of the movement of the mouse or pointer.

### FIELD OF THE INVENTION

This invention relates to computer mouse and pointing devices, systems and software.

### BACKGROUND OF THE INVENTION

A computer pointing system is a universal human computer interface. The user moves an image of a cursor or pointer on the computer display screen by applying a mechanical movement to a coordinate input device such as a mouse. The mouse generates pulses proportional to the movement in x and y directions. The pulses are counted as a measure of the movement of the mouse. The movement of the mouse is scaled to obtain proper resolution and movement of the pointer. The mechanical movement may be the movement of a mouse or pen, the rotation of a track ball, or the movement of finger on a touch pad.

The speed of the pointer is user selectable. However, with a higher speed, the resolution is reduced proportionally and fine movement of the pointer becomes more difficult. On the other hand, with a small speed, for a large movement of the pointer, a large movement of the mouse is required.

To overcome this problem, current computer pointing systems use high speed of the mouse as an indication of pending large movement of the pointer on the computer screen and automatically increase the speed accordingly to reduce the required time and the movement of the mouse. See U.S. Pat. Nos. 5,195,179 and 5,191,641.

In the latest Microsoft Windows the tool tip on the acceleration option of mouse settings reads “Select an acceleration option to determine the distance the pointer moves on the computer screen in response to how quickly you move the mouse.” The tool tip for the speed slider reads “Drag the slider to determine how far the pointer moves on the computer screen in response to how far you move the mouse. For greater precision, set the speed in the slow-to-medium range.”

However, with small speed, the mouse must move a large distance for large movements of the pointer. For fast movement of the pointer, the user must provide sudden movements to the mouse. Besides excessive stress on the hand, the user looses full control of the pointer. Generally, the pointer undershoots and does not reach the target in one stroke, or overshoots and passes the target. Therefore, an extra movement of the mouse is required to bring the pointer over the target.

Still, most of the time the hand must stretch or move from its resting position for large movements of the pointer. Frequently, the mouse reaches the extremities of its working space and must be lifted and repositioned.

In slow mode, the pointer requires about 5 cm of mouse movement for a full scan across the screen. In fast mode it takes about 2 cm for a full scan across the screen.

In a track ball wherein a ball is rotated by finger, fast movement is even less practical. For large movements of the pointer, the user's finger must reciprocate a few times for the required rotation of the ball.

Even at the lowest speed or highest resolution of the mouse in a conventional computer some tasks such as placing the pointer between two letters or nudging in simple drawings or moving borders require excessive attention and very fine movements of the mouse.

In U.S. Pat. No. 5,760,763 the pointer follows the mouse movement within a predefined select area and continues moving automatically beyond the select area. An additional task is required to stop the automatically moving pointer.

U.S. Pat. No. 5,398,044 uses a button to initiate automated movement of the mouse. Here same feedback problem and complication of the pointing device and process exist.

U.S. Pat. No. 5,164,713 uses a contact sensing frame around the mouse to reposition a zone of limited pointer movement on the computer screen when the mouse contacts the frame.

U.S. Pat. No. 5,153,571 provides a button on the mouse, which can be used to gradually change the speed of the pointer.

The repetitive process of pointing should take the least amount of attention and minimum number of tasks and peripheral parts. The extra step in the above patents complicates the pointing process. The extra step takes extra attention, effort, and time and more than offsets any advantage that might be realized from the invention. Any additional part in the above patents makes them less practical.

On a daily basis, computer users move the mouse a large number of times. In the long term this repetitive task poses serious risk of injury to the hand and arm.

Therefore, an ergonomic computer pointing system reducing the amount and speed of hand movement and stress to the hand and arm is of crucial importance. Also, a smaller movement of the mouse reduces effort, saves time and improves efficiency and productivity.

### OBJECTS OF THE INVENTION

The objects of the invention include:

1. To provide an ergonomic computer pointing system with smooth operation wherein the pointer on the computer screen can be moved around with a smaller or slower movement applied to a mouse while providing high resolution for the pointer when required.

2. To make the above pointing system transparent to the user, so it does not require extra attention or activity as compared to conventional pointing systems.

3. To reduce the stress and risk of hand injury by reducing the required speed and movement of the mouse.

4. To apply the invention to all types of coordinate input devices including mouse, track ball, touch pad, pen or joystick.

5. To achieve the above objectives by changing the speed of the pointer based on the distance the mouse or pointer is moved.

### DESCRIPTION OF THE DRAWINGS

FIG. 1 shows a computer display screen with the pointer inside the assumed window.

FIG. 2 shows the pointer and window position where the mouse has moved the pointer continuously beyond the widow.

FIG. 3 shows updated window after the mouse has stopped or reduced speed below a predetermined value.

FIG. 4 is a flow chart demonstrating the basic principles and procedures of the invention.

FIG. 5 is a flow chart demonstrating method and procedure to modify the coordinate pulses generated by the movement of the mouse according to the method of FIG. 4.

FIG. 6 is a flow chart demonstrating a different method and procedure of the invention.

FIG. 7 is a flow chart demonstrating method and procedure to modify the coordinate pulses generated by the movement of the mouse according to the method of FIG. 6.

### BRIEF DESCRIPTION OF THE INVENTION

According to the invention, there is a computer having a processing unit, a coordinate input device such as a mouse and a display screen. A video image of a cursor or pointer can be moved and positioned on the screen by moving the mouse.

The speed of the pointer is changed according to the amount of movement or travel distance of the mouse or pointer. As the mouse or pointer is moved farther from an initial position, the speed of the pointer is increased. The increase in speed may be linear nonlinear, continuous or stepwise.

When the mouse is stopped or its speed is reduced below a given value the process stops and restarts with the next movement of the mouse.

In one method, the pointer moves at a low speed in fixed relation with the mouse for a first part of the movement of the mouse or pointer. The increase in pointer speed starts after the completion of the first part of the movement.

In another method, the speed of the pointer is increased gradually or stepwise form the beginning of the movement of the mouse or pointer.

In all embodiments and methods any coordinate input device is used in its own conventional way. All conventional functions of the mouse such as clicking remain effective.

### DESCRIPTION OF THE INVENTION

According to the invention, there is a computer having a processing unit, a coordinate input device such as a mouse and a display screen. FIG. 1 shows the computer screen. A video image of a cursor or pointer can be moved and positioned on the screen by moving the mouse.

When the mouse is stationary or moves below a predetermined speed, a region or window with a predetermined size is assumed around the current position of the pointer. This position is called the initial position.

When the mouse is moved, as long as the pointer is within the window, the pointer follows the movement of the mouse with a low speed, which also provides high resolution.

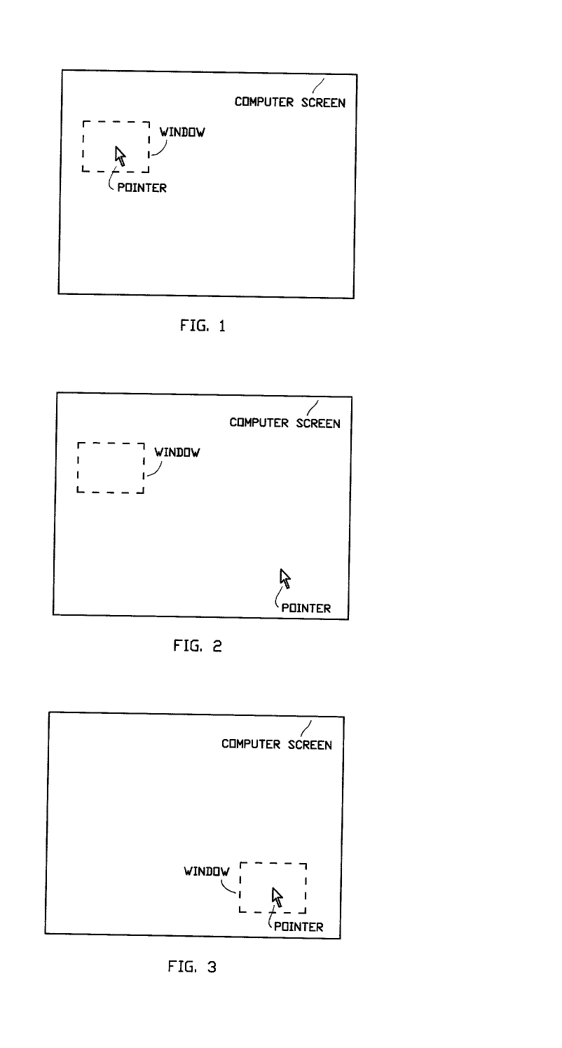

As soon as the pointer moves out of the window, the pointer speed is automatically increased. Therefore, the pointer travels a larger distance with a smaller movement of the mouse. FIG. 2 shows the pointer and window position where the mouse has moved the pointer continuously beyond the widow.

Each time the mouse is stopped or its speed is reduced below a predetermined value the window is updated around the current position of the pointer. FIG. 3 shows updated window after the mouse has stopped or reduced speed below a predetermined value.

Deceleration or reduction in the speed of the mouse below a certain value indicates the intention of the user for high resolution operation or stopping of the mouse. Updating the window allows restart or continuation of the required low speed and high resolution operation of the pointer.

To filter out short time variations in the movement of the mouse, the window is preferably updated only if the change persists for a given time period. This time period is a fraction of a second, preferably about 0.1 to 0.25 second.

Preferably, for a smoother operation, the speed of the pointer is gradually increased as the pointer moves farther from the window or its starting position. Therefore, outside the window but near its borderline, the speed of the pointer is close to the low speed. As a result, the user receives smooth feedback for sustained control.

To achieve this, the low speed of the pointer is increased by a speed factor, which is a function of the distance between the pointer and the border or center of the window. The distance used for the speed factor is preferably the larger of x or y distance of the pointer relative to the border or center of the window. The speed factor is applied to both x and y coordinates of the pointer.

The speed factor function may be linear or nonlinear. The constants of the function may be user selectable.

The window is preferably rectangular with the same orientation and proportion as the computer screen but with a smaller size. This allows easy monitoring and calculation of the coordinates and speeds of the pointer in x and y directions.

The width and height of the window are preferably about 1/10 those of the screen. With this value, the pointer starting at the center of the window, moves ½ the window dimensions or 1/20 of the screen dimensions before starting high speed mode. The size of the window may be user selectable.

In a continuous movement of the pointer across the screen, the total movement of the mouse would be about 0.25 cm for the window and 0.75 cm for the rest of the screen. A total continuous mouse movement of about 1 cm moves the pointer across the whole screen.

Generally, the invention reduces the required movement of a conventional pointing system by a factor of about 2 to 4 while providing better precision and control.

With this system, the user always moves the mouse slowly and smoothly and has control for feedback approach toward the target position. For all kinds of coordinate input devices the hand can rest on a surface or pad and move the pointer across the screen with a small and smooth movement within the comfort zone of the hand or finger.

Since the mouse always moves at a low speed it can be stopped in a shorter time. This provides better control and reduces the chance of the pointer moving beyond the target position.

The invention substantially reduces the chance of the mouse running out of space or requiring frequent lifting and repositioning.

Besides ergonomic advantages, a smaller movement of the mouse reduces effort, saves time and improves efficiency and productivity.

The invention relies on the fact that for high resolution, the mouse is moved form rest or at a substantially low speed for a short distance. The change in the speed of the mouse is used only as a condition or starting point to increase the speed of the pointer in response to how far the mouse is moved.

The concept of window here is used for easy demonstration and visualization of the invention. The principle of the invention may be described in a different way. When the mouse is stationary, or its speed reaches below a predetermined value the current position of the pointer is used as initial position.

When the mouse is moved, for a predetermined length relative to the initial position, the pointer follows the movement of the mouse with a low speed, which also provides high resolution. In other words, a small speed factor is used.

As soon as the pointer moves beyond the predetermined length, the pointer speed is automatically increased. In other words, the pointer follows the movement of the mouse with a large speed factor. Therefore, the pointer travels a larger distance with a smaller movement of the mouse. The predetermined length may be along the pointer path or x or y axis.

Each time the mouse is stopped or its speed is reduced below a predetermined value the initial position of the pointer is updated at the current position of the pointer.

Deceleration of the mouse or reduction of its speed below a certain value indicates the intention of the user for high resolution operation or stopping of the mouse. Updating the initial position allows restart or continuation of the required low speed operation of the pointer.

To filter out short time variations in the movement of the mouse, the reference position is preferably updated only if the change persists for a given time period. This time period is a fraction of a second, preferably about 0.1 to 0.250 second.

The principle of the invention may be described in still another different way. A timer is associated with the movement of the mouse. When the mouse is stationary, or its speed reaches below a predetermined value, the timer is reset.

When the mouse is moved, for a predetermined time interval, the pointer follows the movement of the mouse with a low speed, which also provides high resolution. In other words, a small speed factor is used.

As soon as the time interval is passed, the pointer speed is automatically increased. In other words, the pointer follows the movement of the mouse with a large speed factor. Therefore, the pointer travels a larger distance with a smaller movement of the mouse.

The speed of the pointer is preferably increased gradually as a function of the time beyond the predetermined time interval. The function may be linear or nonlinear.

Each time the mouse is stopped or its speed is reduced below a predetermined value the timer is reset.

Deceleration of the mouse or reduction of its speed below a certain value indicates the intention of the user for high resolution operation or stopping of the mouse. Resetting the timer allows restart or continuation of the required low speed operation of the pointer.

To filter out short time variations in the movement of the mouse, the timer is preferably reset only if the change persists for a given time period. This time period is a fraction of a second, preferably about 0.1 to 0.250 second.

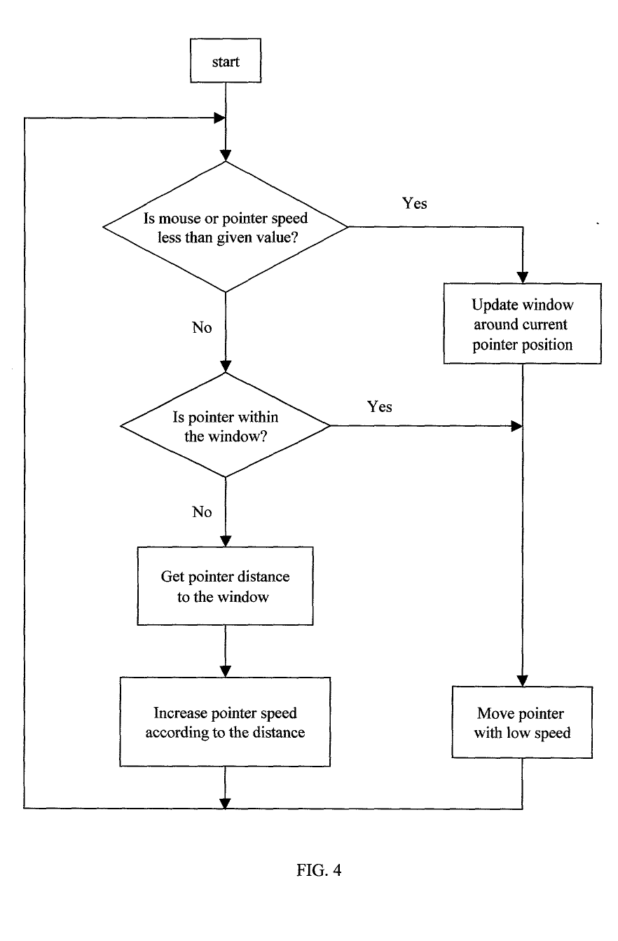

FIG. 4 shows a flow chart demonstrating the basic principles and procedures of the invention.

In the first preferred embodiment of the invention, a computer program gets the x and y coordinates of the pointer, modifies them according to the invention and then returns the modified values as the current position of the pointer.

The program repeatedly gets the coordinates of the pointer at the beginning and end of a short time interval and uses the difference in the coordinates as a measure of the movement of the mouse. The amount of movement during the time interval is multiplied by the proper speed factor and added to the coordinates of the pointer at the end of the time interval. The modified coordinates define the current position of the pointer. To reduce the load on the processing unit the repetition rate may be limited to about 20 times per second.

The speed factor has a value of SF=A for the low speed of the pointer and a value of SF=A+C (DX) or SF=A+C (DY) for the high speed of the pointer.

Here, A and C are constants and DX and DY are movements of the pointer in a given time interval. The value of A is less than or equal to 1. The larger of DX and DY is used in calculating SF.

When A is less than 1 the initial pointer speed is lower than the normal speed of the pointer, thus providing very high resolution and very low speed. When A is equal to 1 the initial pointer speed is the normal speed of the pointer.

The program can be part of a mouse driver program, an operating system or an application program.

The movement of a mouse is originally measured by counting the number of electrical pulses it generates in x and y directions. The speed of the movement is measured by the frequency of the pulses.

In another approach, the pulses from x and y coordinate outputs of the mouse are modified according to the invention and then returned as the original mouse outputs.

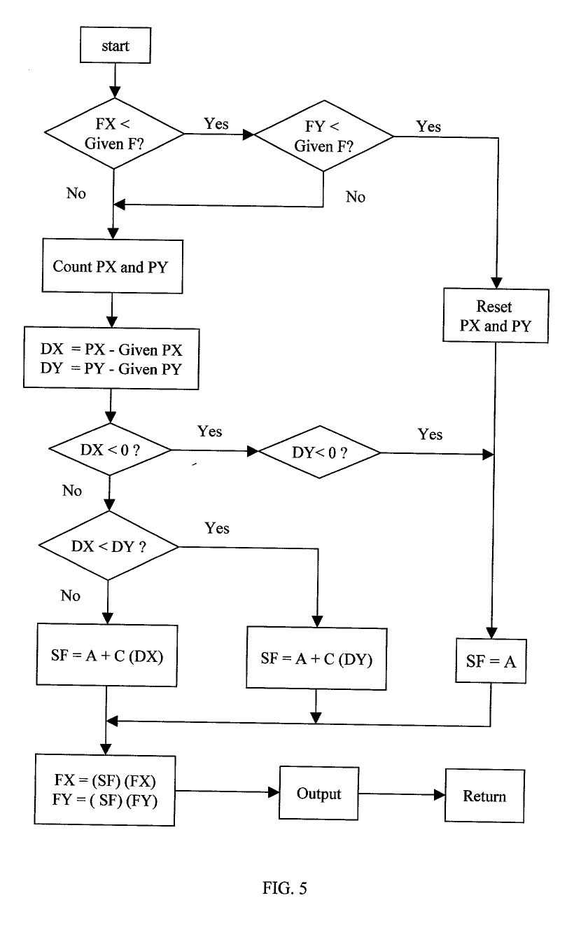

FIG. 5 is a flow chart for this method. In this flow chart X and Y represent values for x and y coordinates. FX and FY are the pulse frequencies of the mouse, F is a predetermined or given pulse frequency. PX and PY are the numbers of counts of the pulses, DX and DY are pulse counts beyond the predetermined or given pulse counts, SF is the speed factor and C is the constant of proportionality.

First, FX and FY are checked against the predetermined or given frequency F. When both are smaller than F it means the speed of the mouse is below the predetermined value and low pointer speed is required. Therefore, a speed factor of SF=A is used for FX and FY where A<=1.

Otherwise, PX and PY and their differences DX and DY with their respective predetermined or given values are found. When both DX and DY are less than or equal to zero, low pointer speed is required. Therefore, a speed factor of SF=A is used for FX and FY.

When DX or DY is higher than zero, high pointer speed is required. If DX is larger than DY a speed factor of SF=A+C (DX) is used for both FX and FY. Otherwise a speed factor of SF=A+C (DY) is used for both FX and FY.

When using pulse counts, updating of the window or the reference position of the pointer is equivalent to resetting the counters.

In the second preferred embodiment of the invention, a computer program modifies the pulses of the mouse according to the flow chart of FIG. 5 and returns the modified values for the position and speed of the pointer. The program can be part of a mouse driver program, an operating system or an application program.

In the third preferred embodiment of the invention, an electronic circuit modifies the pulses of the mouse according to the flow chart of FIG. 5 and returns the modified values for the position and speed of the pointer. With this embodiment, the pointer will operate according to the invention while the original computer mouse driver software performs its normal operation.

In the fourth preferred embodiment of the invention, the electronic circuit of the third preferred embodiment is integrated with the computer.

In the fifth preferred embodiment of the invention, the electronic circuit of the third preferred embodiment is disposed between the mouse and the computer.

In the sixth preferred embodiment of the invention, the electronic circuit of the third preferred embodiment is integrated with the mouse.

The implementation of the invention in the form of either a computer program (software) or an electronic circuit (hardware) is well known in the art.

The software implementation of the invention may be an independent device driver using the output of the mouse, or a device driver cooperating with the device driver or the processing unit of the computer.

The hardware implementation of the invention may be analog or digital. In digital implementation of the method in FIG. 5 each task is performed by a digital circuit or device which is well known in the art. Predetermined values are set by switches or memory devices.

In analog implementation of the method in FIG. 5, the coordinate frequencies are converted to voltages. Predetermined values are set as reference voltages. Comparisons and calculations with the voltages are performed with analog circuits and devices. The final values are voltages representing the modified speed of the mouse, which are converted to frequencies and returned to the computer processing unit.

The hardware may have switches or potentiometers for the user to select the amount of initial movement of the pointer at low speed or the increase in speed after the initial movement of the pointer.

The principle of the invention may be extended to using a very small inner window at the center of a small outer window. The dimensions of the inner window are preferably about 1/10 the outer window or about 1/200 the dimensions of the screen. Within the inner window, the pointer is moved at very low speed and very high resolution. Within the outer window, the pointer is moved at low speed and high resolution. Outside the outer window, the pointer is moved at high speed and low resolution.

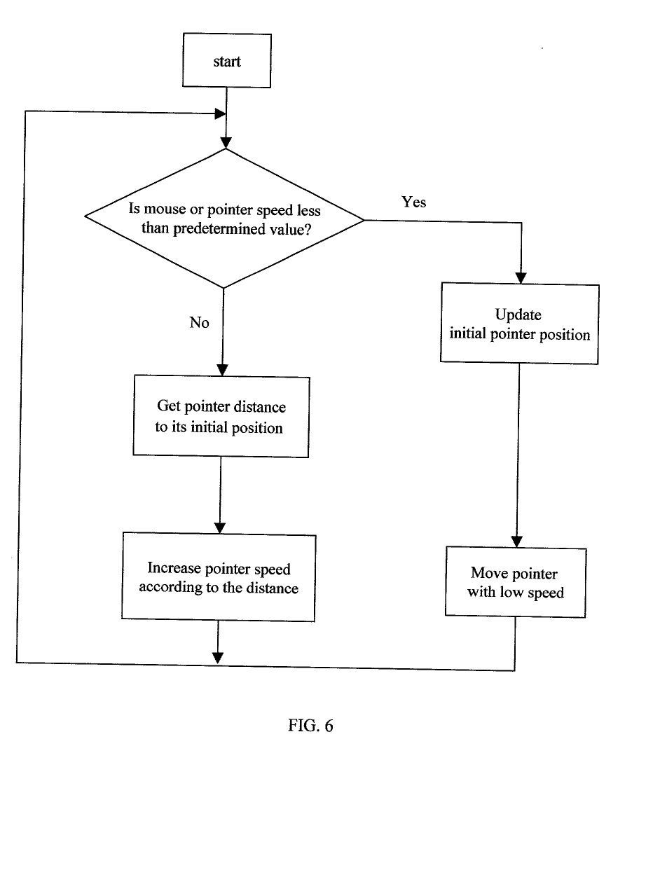

A special case of the invention is when the dimensions of the window are zero. In other words, the increase in the speed of the pointer starts as soon as the mouse moves from rest or its speed increases beyond the predetermined value. FIG. 6 is a flow chart for this case.

In this case, it is preferable to increase the speed by a speed factor, which increases at a smaller rate in the initial movement of the mouse and at a larger rate for the rest of the movement. Such a function may have a general form of SF=A+C (DX)^{N} or SF=A+C (DY)^{N} where A, C, and N are constants and DX and DY are movements of the mouse in a given time interval. The value of A is less than or equal to 1. When A is less than 1, the pointer speed starts at a value that is lower than the normal speed of the pointer, thus providing very high resolution and very low speed. When A is equal to 1, the pointer speed starts at the normal speed of the pointer.

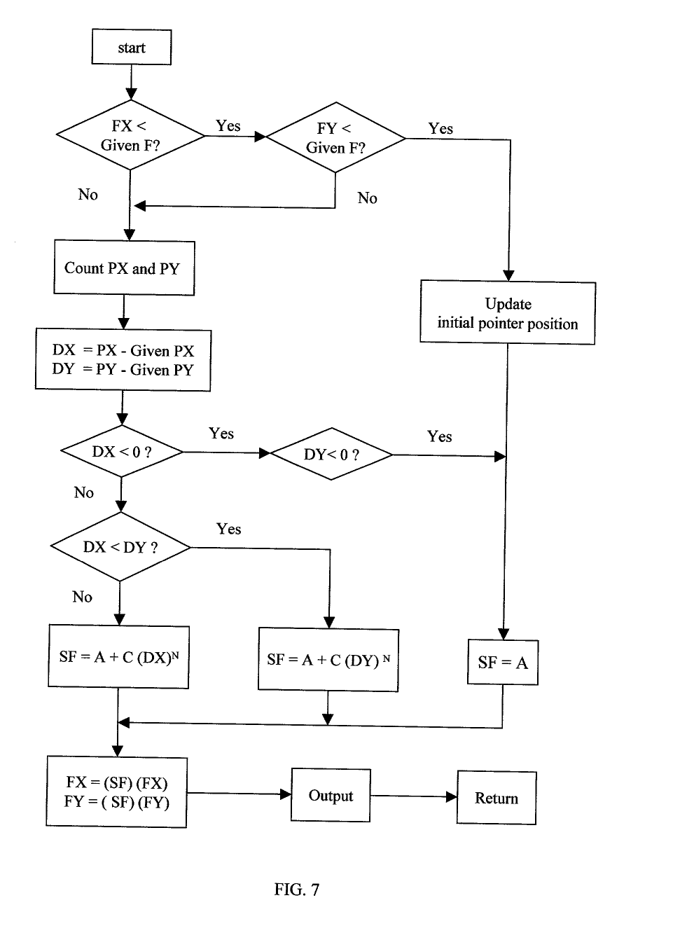

FIG. 7 is a flow chart for modifying the x and y pulse counts of the mouse according to the method of FIG. 6. The parameters are same as those in the description of FIG. 5.

The method in FIG. 6 and its variations may be implemented in different hardware and software forms similar to methods and embodiments described earlier.

In all embodiments that include very high resolution, when the mouse is stopped for clicking, it would be in very high resolution mode. This advantageously reduces the sensitivity of the pointer to small movements of the mouse during clicking.

In all embodiments, the speed factor may be defined as a piecewise linear function. To further simplify the process, the speed factor may be defined as a series of constant values in relation to the amount of movement of the mouse or pointer. These values may be stored in the form of a lookup table. In hardware form, these values may be set by switches or stored in memory devices in a digital circuit or by reference voltages in an analog circuit. In all embodiments and methods, any coordinate input device is used exactly in its own conventional way. All conventional functions of the mouse such as clicking remain effective.

This invention may be embodied in other forms without departing from the spirit or basic principles thereof. The present methods, procedures and embodiments are to be considered as illustrative and not restrictive.

I claim:

1. A computer pointing system comprised of:
a processing unit,
a display screen;
a coordinate input device generating electric signals or pulses in relation to the movement imparted by a user;
a video image of a cursor or pointer on the display screen;
the pointer is moved on the screen with a first speed for an initial part of the user's movement and with a second speed for the remaining part of the user's movement, the second speed being higher than the first speed.

2. The computer pointing system of claim 1 wherein the first speed is in fixed relation to the user's movement.

3. The computer pointing system of claim 1 wherein the second speed is in fixed relation to the user's movement.

4. The computer pointing system of claim 1 wherein the first speed increases in relation to the distance of the user's movement.

5. The computer pointing system of claim 1 wherein the second speed increases in relation to the distance of the user's movement.

6. The computer pointing system of claim 1 wherein a computer program controls the relation between the user's movement and the pointer.

7. The computer pointing system of claim 1 wherein an electronic circuit controls the relation between the user's movement and the pointer.
